(19) United States
(12) Patent Application Publication
(10) Pub. No.: US 2013/0175119 A1
(43) Pub. Date: Jul. 11, 2013

(54) COLLAPSIBLE LADDER

(71) Applicant: Marcus Holmberg, Tranas (SE)

(72) Inventor: Marcus Holmberg, Tranas (SE)

(73) Assignee: TELESTEPS AB, Tranas (SE)

(21) Appl. No.: 13/808,818

(22) PCT Filed: Jul. 7, 2011
(86) PCT No.: PCT/EP2011/061481

§ 371 Date: Mar. 22, 2013

(30) Foreign Application Priority Data
Jul. 8, 2010 (SE) 1050754-9

(51) Int. Cl. E06C 1/12

(52) U.S. Cl. CPC E06C 1/125
USPC 182/129

(57) ABSTRACT

A collapsible ladder (100), comprises a number of tube portions (210, 220, 310, 320) having various diameters and being telescopically insertable into one another. The upper end of a first tube portion (210, 310) is connected to one end of a ladder step (230, 330) and the other end of the ladder step (230, 330) is fastened to an upper end of a second tube portion (220, 320) having the same diameter as the first tube portion (210, 310). The first (210, 310) and second tube portions (220, 320) and the ladder step (230, 330) form a ladder section (200, 300), the tube sections of which being insertable into an adjacent ladder section comprising tube portions having a larger diameter, wherein the ladder sections may be mutually interlocked by interaction between pins (280) located in the ladder steps (230, 330) and openings provided in the tube portions of a neighboring ladder section. The pin (280) of a lowest ladder section (200) may be withdrawn from interaction with its respective opening in the tube portions (310, 320) of the neighboring ladder section (300) by manipulating a foot control (250) located below a low ladder step (240) of the lowest ladder section (200) and being arranged to be maneuvered by a foot of a user of the ladder (100).

### FIELD OF THE INVENTION

The present invention relates to a collapsible ladder comprising a number of tube portions having various diameters and being telescopically insertable into one another. The upper end of a first tube portion is connected to one end of a ladder step and the other end of the ladder step is fastened to an upper end of a second tube portion having the same diameter as the first tube portion. The first and second tube portions and the ladder step form a ladder section, the tube sections of which being insertable into an adjacent ladder section comprising tube portions having a larger diameter. The ladder sections may be mutually interlocked by interaction between pins located in the ladder steps and openings provided in the tube portions of a neighboring ladder section.

### Prior Art

As well known by persons skilled in the art of collapsible ladders, such ladders usually comprise a number of tube portions having various diameters and which hence are telescopically insertable into one another. Every upper end of any of the tube portions are fastened to one end of a ladder step, whereas the other end of the ladder step is fastened to an upper end of a tube portion having the same diameter, the two tube portions and the ladder step forming a ladder section, the tube sections of which being insertable into an adjacent ladder section comprising tube portions having a larger diameter.

The resulting ladder can hence be collapsed by inserting higher ladder sections into lower ladder sections, and the ladder can be extended by extracting higher ladder sections from the lower ladder sections. A pin extending through the holes in the outer walls of two adjacent tube portions locks the tube portions to prevent the extended ladder from collapsing.

There are basically two types of collapsible ladders, namely auto-collapsing ladders and manually collapsible ladders. The autocollapsible ladders comprise locking pins being connected to a release mechanism situated on the underside of the ladder step, such that the locking pin is retracted from engagement with the holes in the outer walls of the upper ladder sections when the release mechanism contacts the ladder step of the ladder section below.

However, in order to collapse an autocollapsible ladder, it is necessary to manually release the locking pins of a lowest ladder section; after those pins have been released, the adjacent above ladder section may be inserted into the lowest ladder section, whereupon the locking pins of this ladder section will be released by interaction between the ladder step of the lowest ladder section and the release mechanism of the second lowest ladder section, which in turn will release the third lowest ladder section, and so on, until the ladder is fully collapsed.

Generally, the lowest ladder section comprises at least two ladder steps, a top ladder step and a low ladder step situated between the tube portions on a lower level than the top ladder step. The manual release of the locking pin is placed on the top ladder step of the lowest ladder section.

Although this has proven to give a very handy and sturdy ladder with a reliable function, it has also proven to give some inconveniences when it comes to collapsing the ladder; for collapsing a ladder of this type, a user must lean forward to release the manual release mechanism with one hand, while he holds the ladder with his other hand.

In U.S. Pat. No. 2,127,949, a stepladder comprising a foot release (40) is shown. However, the foot release can only be used when the stepladder is in a ready-to-use position, i.e. unfolded in an A-shaped configuration.

CN200720059697.5 discloses a ladder having a foot release which might facilitate the folding of the ladder. This foot release is provided on a lowe ladder step situated on a completely irregular position visavi the remaining ladder steps, and might therefore pose a risk for a user of the ladder. The positioning of the foot release makes the design sensitive to inadvertent maneuvering of the foot release, and hence dangerous to use, since maneuvering of the foot release will collapse the ladder.

It is the object of the present invention to provide a ladder which can be easily and conveniently collapsed without the need for a user to lean forward to release the manual release mechanism. It is also an object of the present invention to provide a ladder which may be conveniently held with both hands during the release of the pins holding the second lowest ladder section. Still another object of the present invention is to provide a ladder having a reduced risk for inadvertent collapsing of the ladder.

### SUMMARY OF THE INVENTION

The present invention solves the above and other problems by a ladder wherein the pin of a lowest ladder section may be withdrawn from interaction with its respective opening in the tube portions of the neighboring ladder section by manipulating a foot control located below a low ladder step of the lowest ladder section and being arranged to be maneuvered by a foot of a user of the ladder.

In order to have a secure and reliable foot release, the foot control may be arranged as a footstep, being adapted to release its corresponding pin by being pushed in a downward direction.

### BRIEF DESCRIPTION OF THE DRAWINGS

In the following, the invention will be described with reference to the appended drawings, wherein:

FIG. 1 is a perspective view showing three ladder sections of a collapsible ladder in an extended state

### DESCRIPTION OF EMBODIMENTS

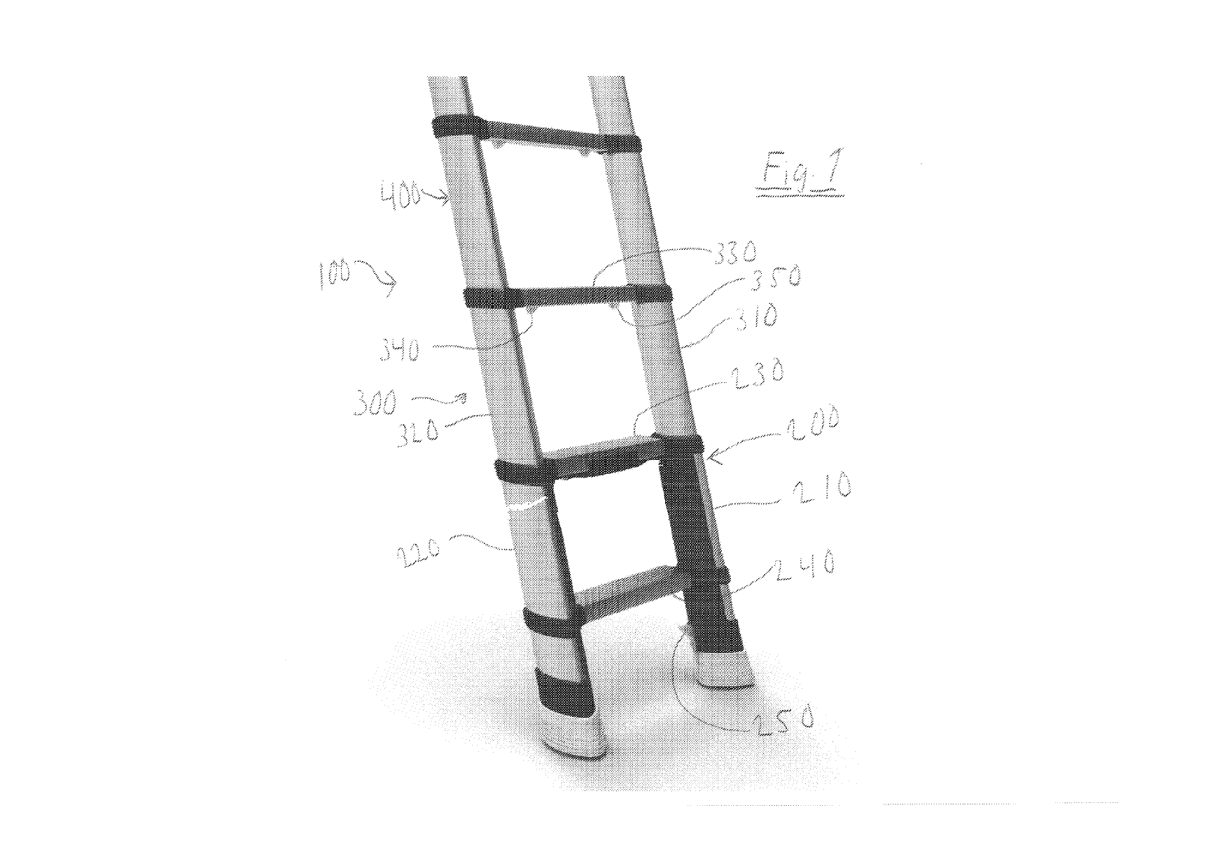

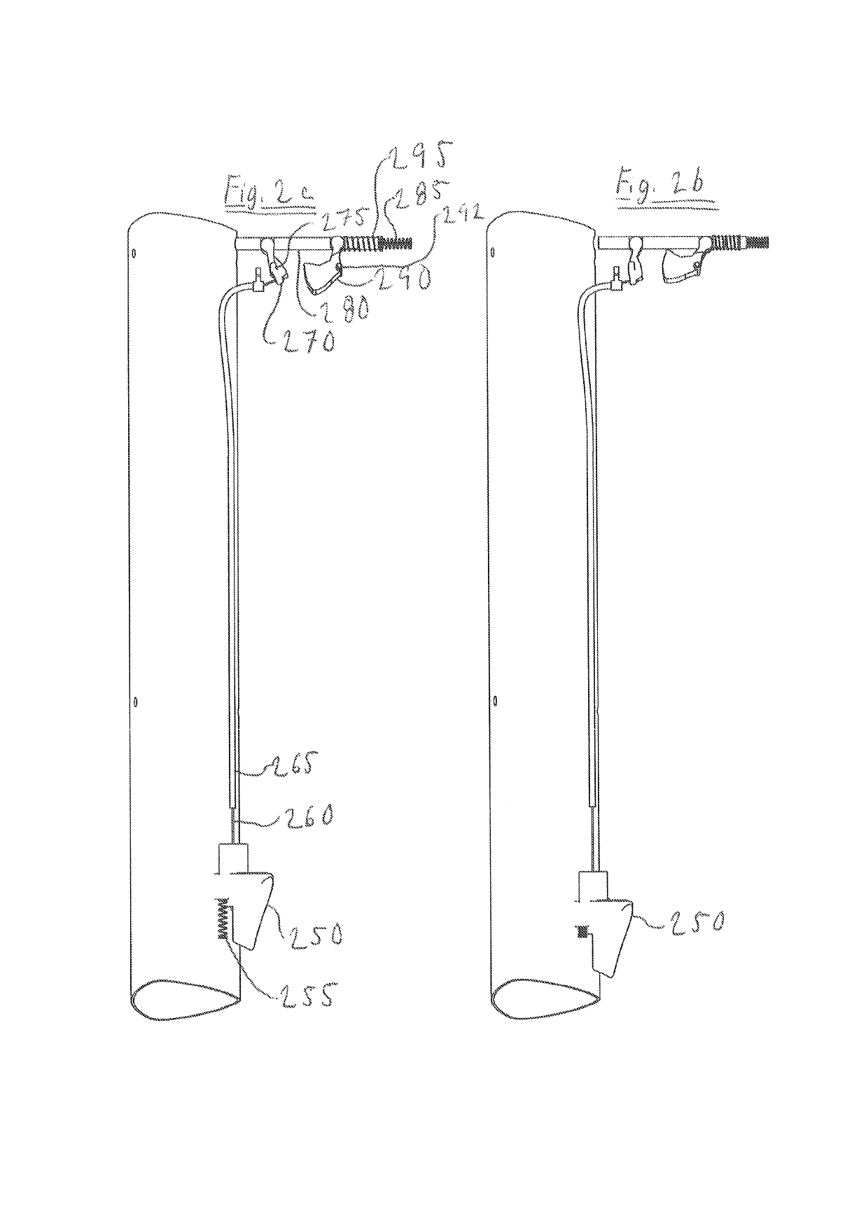

In FIG. 1, a first embodiment of a ladder 100 according to the present invention is shown. The ladder 100 comprises a lower ladder section 200 comprising two tube portions 210, 220, which are connected by a top ladder step 230 and a low ladder step 240. The lower ladder section 200 also comprises two foot releases 250 (only one shown in FIG. 1), which are movable in a downward direction and connected to pins 280 (se FIGS. 2a and 2b) placed in the top ladder step 230 and arranged to lock the lower ladder section 200 to an intermediate ladder section 300, comprising two tube portions 310, 320, the top ends of which being connected to one another by a ladder step 330, in a way to be described later. The tube portions 310, 320 have an outer diameter or section being smaller than an inner diameter or section of the tube portions 210, 220, such that the tube portions 310, 320 may telescope inside the tube portions 210, 220 between an extended state and a collapsed state.

The ladder step 330 of the ladder section 300 also comprises two locking pins (not shown), which are arranged to lock an upper ladder section 400 when the ladder section 400 is extended vis-à-vis the ladder section 300. The locking pins of the ladder step 330 are operatively connected to levers 340, 350, such that the locking pins 340, 350 are retracted from engagement with the ladder section 400 when the levers 340, 350 contact the ladder step 230. The interaction between the levers 340, 350 will hence allow the ladder section 400 to collapse, i.e. perform a telescoping movement into the tube portions 310, 320. The ladder section 400 and all ladder sections above it (except for a top ladder section, which may be manufactured without levers and locking pins) are provided with similar levers and locking pins, which will allow all the above ladder sections to collapse into the an adjacent ladder section once the pins of a lower ladder section have been released from engagement with the tube portions of such ladder section.

The invention is not restricted for use on ladders having visible levers 340, 350. Rather, the invention is applicable to all kinds of collapsible telescopic ladders having a similar design, e.g. ladders having hidden levers, which may be actuated by e.g. small pins extending from the ladder step below the hidden levers.

It should be noted that the foot releases 250 are placed below the low ladder step 240; this position will decrease the risk that the foot releases are maneuvered inadvertently significantly as compared to prior art designs.

FIGS. 2a and 2b show an exemplary embodiment of a connection between the footstep 250 and the pin located in the footstep 230, wherein FIG. 2a shows the pin being in the extended state, i.e. locking the ladder bar 320 to the ladder bar 220, and wherein FIG. 2b shows the pin being in the retracted state, i.e. unlocking the ladder bar 320 from the ladder bar 220.

The connection according to the shown embodiment comprises the footstep 250, which is urged in an upward direction by a spring 255. The footstep 250 is connected to a wire 260, which at least partly may be housed within a wire housing 265. It may also be possible to house the wire within a framework covering the internal surfaces of the lower ladder section. The wire housing and the wire extend up towards a lever 270, one end of which being fastened to the wire 260, the other end of which being fastened to the pin 280. The lever 270 is hinged in a central portion, such that when the end of the lever to which the wire is fastened is pulled to the left, the end to which the pin 280 is fastened moves to the right. The pin 280 is urged to the left (i.e. to an extended position, where the pin 280 locks the ladder section 300 by interacting with holes in this ladder section) by a spring 285.

The mechanism according to the shown embodiment also comprises a tell lever 290. The tell lever has no function, except for showing a user whether the pin is in a retracted position (i.e. a position to the right) or an extended position. In the same manner as the lever 270, the tell lever 290 is hinged around a central portion 292, such tha an end of the tell lever not being fastened to the pin 280 will move in an upward direction when the pin 280 is moved to the left. The fastening of the lever 290 to the pin 280 is made such that the end of the tell lever 290 which is fastened to the pin always will follow the pin when the pin is moved to the left (meaning that the opposite end of the tell lever will move upwards), whereas the same end will follow the pin 280 in the opposite direction provided that a spring 295 is not compressed. The spring 295 is considerably less powerful than the spring 285.

This will lead to the effect that it is impossible to retract the pin 280 by pressing the tell lever 290 upwards; such a movement will simply compress the spring 295, which, as mentioned, has a lower spring constant than the spring 295.

As mentioned earlier, the only purpose of the tell lever is to alert a user should the pin not be fully inserted in its associated openings (which are not shown); By the provision of the tell lever according to the above, it is absolutely certain that the pin is in the extended position should the tell lever be in its visible position; should the tell lever be invisible, the pin might be in its extended position (if, for example, the tell lever would be jammed).

It should be noted that that the invention is not limited to the embodiments described above; there are many modification possible without departing from the scope of the invention, such as it is defined in the appended claims. One example of such a modification is the design of the footsteps; instead of being designed to be maneuvered by pressing the footsteps downward, the footsteps may be designed to withdraw its respective pin by being moved sideways.

Moreover, the disclosed embodiment shows a mechanism comprising a covered wire. Another embodiment may instead comprise wire running in a path decided by pulleys.

Another possible embodiment includes a modification concerning which pin to be retracted; in the shown embodiments, pressing the right footstep will withdraw the right pin, pressing the left will withdraw the left pin. In an alternative embodiment, pressing either of the footsteps (or pushing it sideways!) will withdraw the pin of the opposite ladder leg. By such a design, it is possible to use a simpler mechanism, without the levers 270. Instead, the wire may be fastened directly to its respective pin.

1. A collapsible ladder, comprising a number of tube portions having various diameters and being telescopically insertable into one another, the upper end of a first tube portion being connected to one end of a ladder step, the other end of the ladder step being fastened to an upper end of a second tube portion having the same diameter as the first tube portion, the first and second tube portions and the ladder step forming a ladder section, the tube sections of which being insertable into an adjacent ladder section comprising tube portions having a larger diameter, wherein the ladder sections may be mutually interlocked by interaction between pins located in the ladder steps and openings provided in the tube portions of a neighboring ladder section, wherein the pin of a lowest ladder section may be withdrawn from interaction with its respective opening in the tube portions of the neighboring ladder section by manipulating a foot control located below a low ladder step of the lowest ladder section and being arranged to be maneuvered by a foot of a user of the ladder.

2. The ladder of claim 1, wherein the foot control is a footstep arranged to be pushed in a downward direction by the user's foot.

3. The ladder of claim 1, wherein the foot control (250) is a footstep arranged to be pushed in a sideway direction by the user's foot.

4. The ladder of claim 1, wherein the foot control of one tube portion is connected to a pin locking a tube portion adjacent to this tube portion.

5. The ladder of claim 1, wherein the foot control of one tube portion is connected to a pin locking a tube portion opposite to this tube portion.
